(19) United States
(12) Patent Application Publication
(10) Pub. No.: US 2014/0355237 A1
(43) Pub. Date: Dec. 4, 2014

(54) INPUT MODULE

(71) Applicants: Ching-Hang Shen, New Taipei City (TW); Fu-Kuei Chang, New Taipei City (TW)

(72) Inventors: Ching-Hang Shen, New Taipei City (TW); Fu-Kuei Chang, New Taipei City (TW)

(21) Appl. No.: 13/906,290

(22) Filed: May 30, 2013

(51) Int. Cl. H01H 13/83

(52) U.S. Cl. CPC H01H 13/83
USPC 362/23.03

(57) ABSTRACT

An input module comprises a flexible body, a sensing electrode, a protection layer, and a lighting device. The flexible body has a first side and a second side. The sensing electrode layer has a first sensing electrode and a second sensing electrode disposed on the second side of the flexible body. The protection layer is correspondingly disposed on the second side of the flexible body to cover the sensing electrode layer. The lighting device is disposed on a side of the protection layer opposite to the second side of the flexible body. Therefore, by means of the combination of the above structures, the input module of the present invention can be made lightweight and easy to carry and use.

### BACKGROUND OF THE INVENTION

1. Field of the Invention

The present invention relates to an input module and in particular to an input module which is easy to carry and use.

2. Description of Prior Art

With the development of the touch panel technology in recent years, the current portable electronic devices with a display function, such as smart phones, tablet PCs and MP5 have used the touch panel to replace the traditional mechanical keys occupying large space.

Tablet PCs, smart phones, and portable electronic devices or TV all tend to be equipped with the functions of handwriting and touch input; it is really convenient for the user's touch operation with fingers or stylus. However, the screens of cell phones, tablet PCs, and portable electronic devices are small, resulting in inconvenience of handwriting input. Therefore, the manufacturers reverse back to use the previously developed mini and/or thin keyboards with mechanical keys, which are easy to carry. The mini and/or thin keyboards are connected to the cell phones, tablet PCs, and portable electronic devices via USB or Bluetooth signals. This enables easy input, but the mini and/or thin keyboards still occupy a certain space, resulting in the disadvantage of inconvenience to carry.

Further, the manufactures develop the combined keyboard and folding keyboard, which are similar to the mini keyboard and make the users difficult to carry. Thus, they can not become essential items for easy carrying.

### SUMMARY OF THE INVENTION

Thus, to overcome the above disadvantages, the primary objective of the present invention is to provide an input module which is easy to carry and use.

To achieve the above objective, the present invention provides an input module comprising a flexible body, a sensing electrode layer, a protection layer, and a lighting device.

The flexible body has a first side and a second side; the sensing electrode layer has a first sensing electrode and a second sensing electrode; the first and second sensing electrodes are disposed opposite to and isolated from each other; the sensing electrode layer is disposed on the second side of the flexible body; the protection layer is disposed on the second side of the flexible body to cover the sensing electrode layer.

The lighting device is disposed on a side of the protection layer opposite to the second side of the flexible body.

By means of the input module of the present invention, it is convenient for the users to carry and operate, as well as overcomes the conventional disadvantages of inconvenience to carry and unpleasant occupation.

### BRIEF DESCRIPTION OF DRAWING

FIG. 1 is an explosive perspective view of an input module according to the first embodiment of the present invention;

FIG. 2 is an assembled perspective view of the input module according to the first embodiment of the present invention;

FIG. 3 is a perspective view of an input module according to the first embodiment of the present invention;

FIG. 4 is a perspective view of the input module according to the second embodiment of the present invention from another view;

FIG. 5 is a perspective view of an input module according to the second embodiment of the present invention;

FIG. 6 is a cross-sectional view of an input module according to the third embodiment of the present invention;

FIG. 7 is a perspective view of an input module according to the fourth embodiment of the present invention;

FIG. 8 is a perspective view of an input module according to the fifth embodiment of the present invention;

FIG. 9 is a perspective view of an input module according to the sixth embodiment of the present invention;

FIG. 10 is a perspective view of an input module according to the seventh embodiment of the present invention; and

FIG. 11 is a perspective view of an input module according to the eighth embodiment of the present invention.

### DETAILED DESCRIPTION OF THE INVENTION

The above objectives of the present invention and the features of structure and function of the present invention are described according to the preferred embodiments in figures.

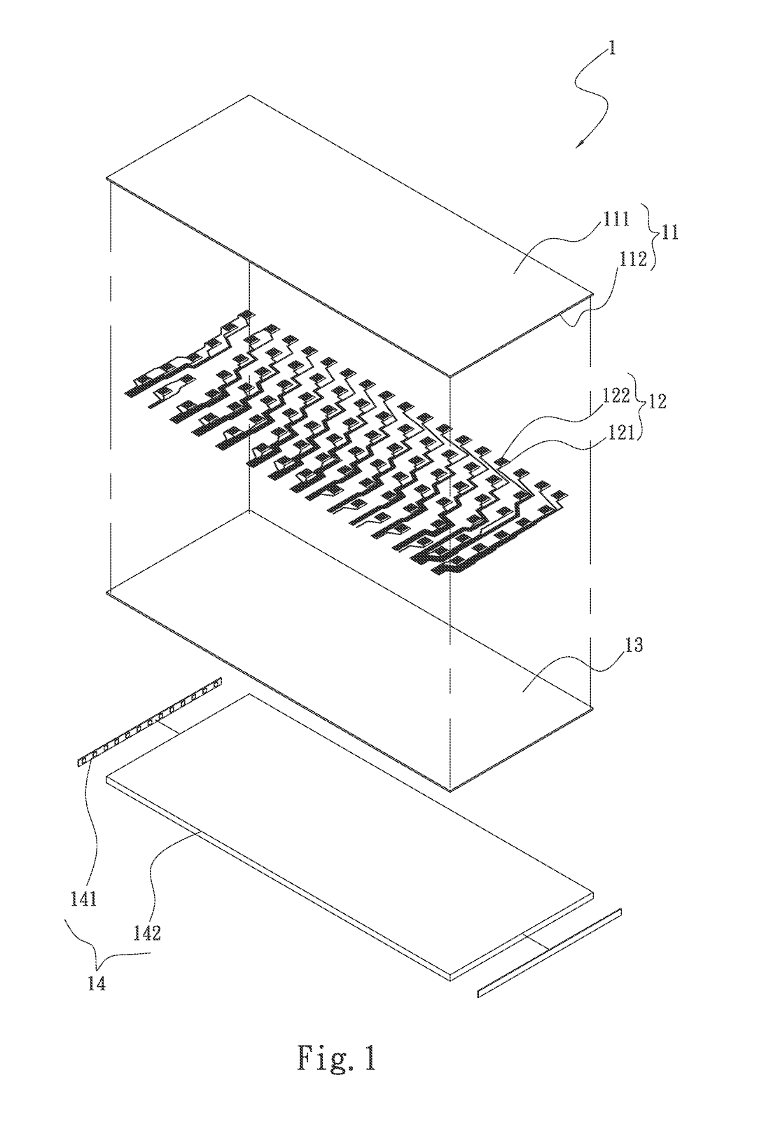

Please refer to FIGS. 1-3, which are the explosive perspective and assembled perspective views of the input module according to the first embodiment of the present invention, respectively. As shown in FIGS. 1-3, the input module 1 comprises a flexible body 11, a sensing electrode layer 12, a protection layer 13, and a lighting device 14.

The flexible body 11 has a first side 111 and a second side 112. The sensing electrode layer 12 which is made of one of transparent and opaque ITO (Indium Tin Oxide), nano silver, and metal paste has a first sensing electrode 121 and a second sensing electrode 122. The first and second sensing electrodes 121, 122 are disposed corresponding to and isolated from each other. The sensing electrode layer 12 is disposed on the second side 112 of the flexible body 11. The protection layer 13 is correspondingly disposed on the second side 112 of the flexible body 11 to cover the sensing electrode layer 12.

The lighting device 14 has at least one lighting unit 141 and an optical component 142. The lighting device 14 is disposed on a side of the protection layer 13 opposite to the second side 112 of the flexible body 11.

The lighting unit 141 may be selected from one of an LED (Light Emitting Diode) and a CCFL (Cold Cathode Fluorescent Lamp). The current embodiment uses the LED for explanation, but not limited to this.

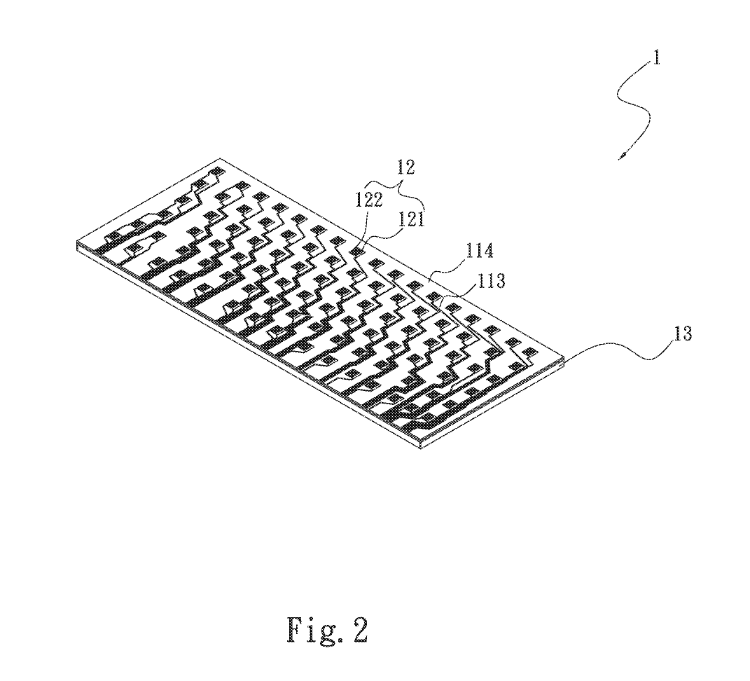

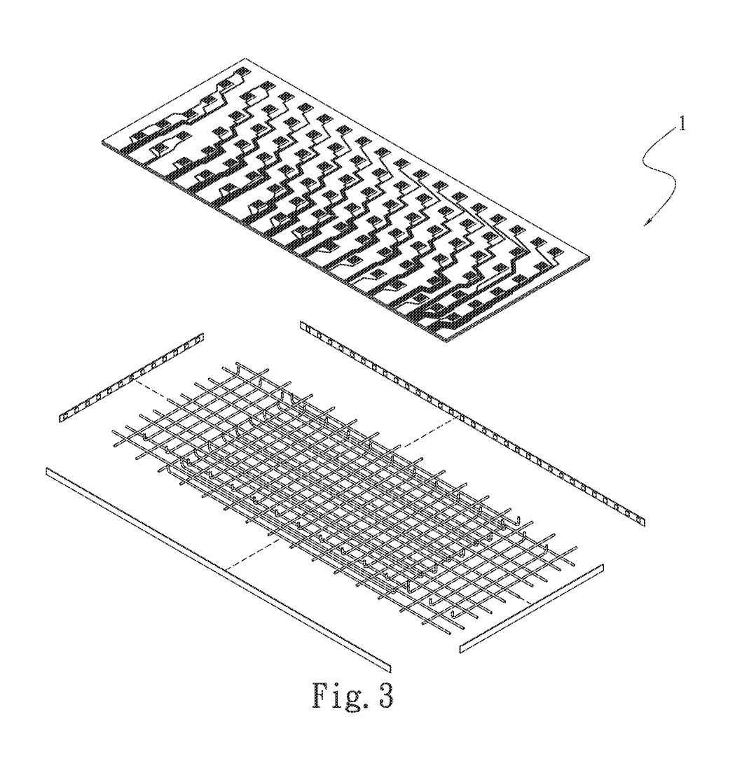

The optical component 142 may be a light guide plate. The lighting unit 141 is connected to at least one side of the optical component 142. The light from the lighting unit 141 is projected to the flexible body 11 via the optical component 142. The optical component 142 may be selected from one of a light guide plate (shown in FIG. 2) and fiber wires (net) (shown in FIG. 3).

The flexible body 11 defines a touch area 113 and a non-touch area 114 disposed at the perimeter of the touch area 113. The first and second sensing electrodes 121, 122 of the sensing electrode layer 12 are disposed within the touch area 113 and partially extend into the non-touch area 114. The first and second sensing electrodes 121, 122 correspond to each other, but do not contact and overlap each other.

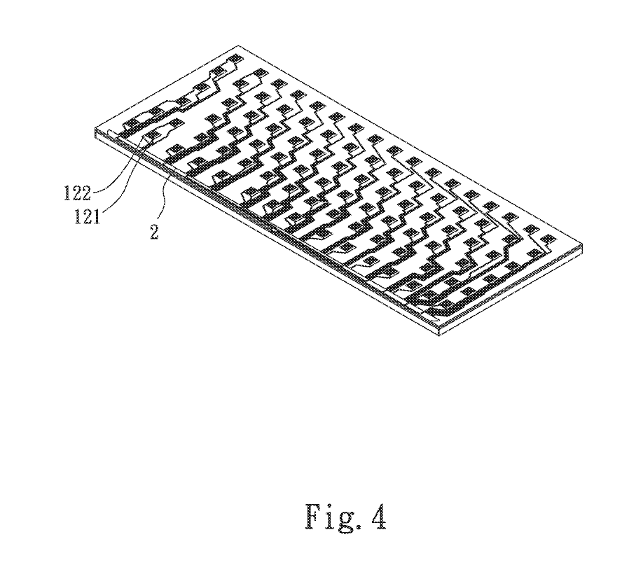

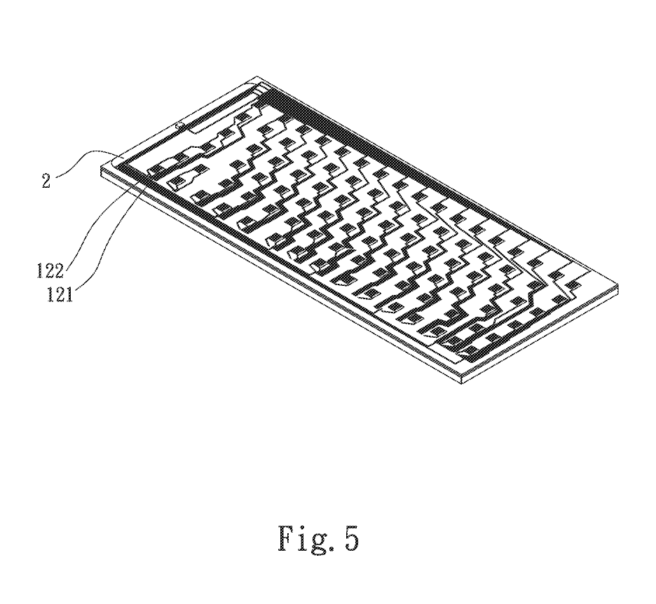

Please refer to FIGS. 4 and 5, which are the perspective views of an input module according to the second embodiment of the present invention. As shown in FIGS. 4 and 5, some structures of the current embodiment are identical to those of the first embodiment and will not be described again here. The difference between the current and the first embodiments is that in the current embodiment, the input module 1 further comprises a flexible circuit substrate 2 which may be disposed selectively at the long side of the flexible body 11 (shown in FIG. 4) or at the short side of the flexible body 11 (shown in FIG. 5). The flexible circuit substrate 2 is electrically connected to the first and second sensing electrodes 121, 122. Also, the flexible circuit substrate 2 can make the input module 1 use in connection with other electronic devices. Alternatively, the input module 1 can receive power from an external power supply (e.g., a mobile power source) via the flexible circuit substrate 2.

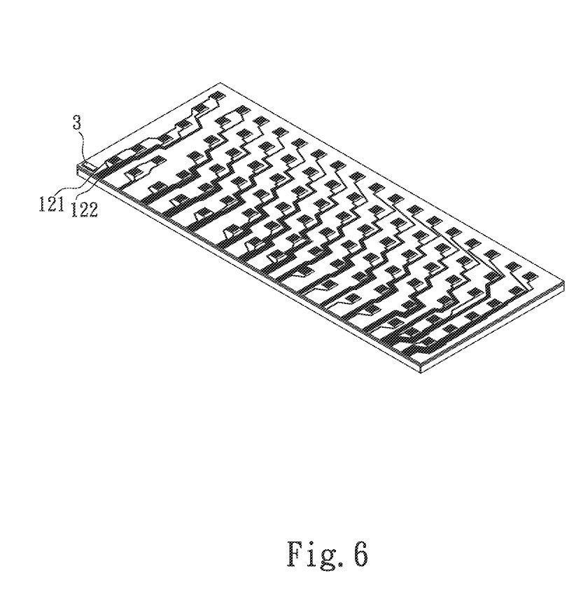

Please refer to FIG. 6, which is the perspective view of an input module according to the third embodiment of the present invention. As shown in FIG. 6, some structures of the current embodiment are identical to those of the first embodiment and will not be described again here. The difference between the current and the first embodiments is that in the current embodiment, the input module 1 further comprises a wireless emitter 3 electrically connected to the first and second sensing electrodes 121, 122. The wireless emitter 3 is selected from one of an IR transmitter, Bluetooth transmitter, RF transmitter, and NCF transmission chip. The wireless emitter 3 can make the input module 1 use in connection with other electronic devices. Alternatively, the input module 1 can receive power via the electromagnetic waves of wireless signals.

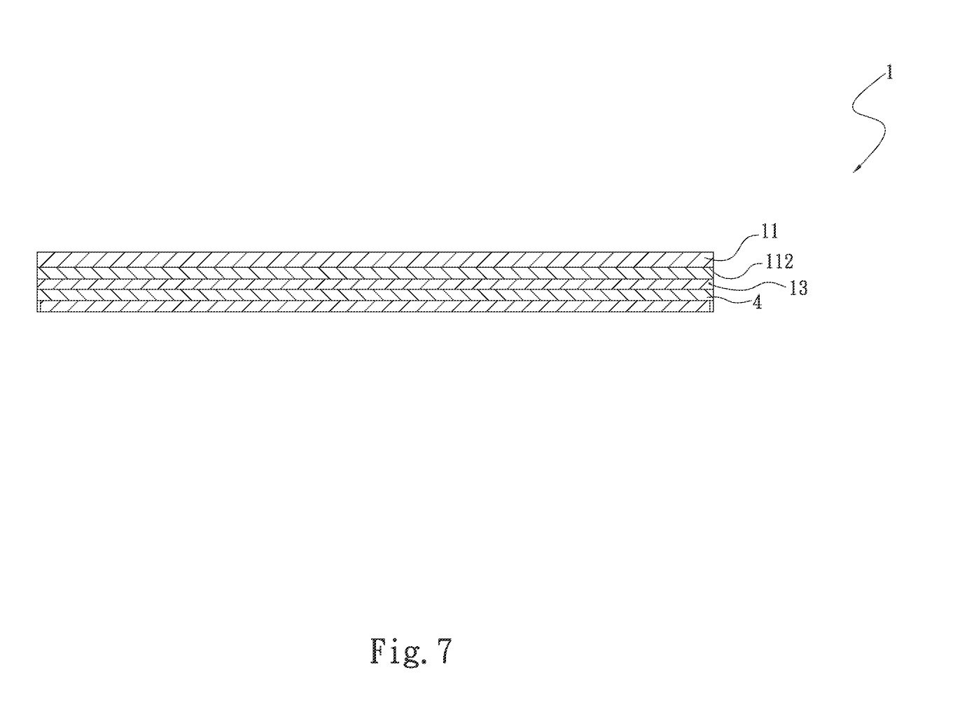

Please refer to FIG. 7, which is the cross-sectional view of an input module according to the fourth embodiment of the present invention. As shown in FIG. 7, some structures of the current embodiment are identical to those of the first embodiment and will not be described again here. The difference between the current and the first embodiments is that in the current embodiment, an anti-interference layer 4 is disposed on the side of the protection layer 13 opposite to the second side 112 of the flexible body 11. The anti-interference layer 4 is an anti-EMI layer which further prevents the transmission signals of the input module 1 from being disturbed and affected by noises.

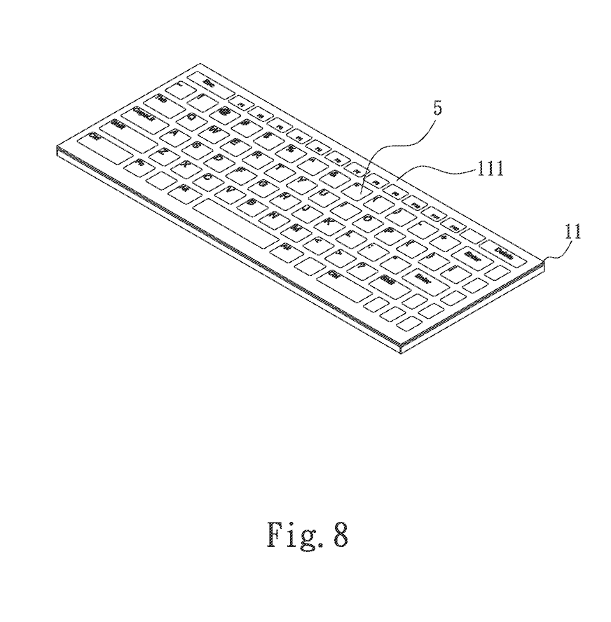

Please refer to FIG. 8, which is the perspective view of an input module according to the fifth embodiment of the present invention. As shown in FIG. 8, some structures of the current embodiment are identical to those of the first embodiment and will not be described again here. The difference between the current and the first embodiments is that in the current embodiment, the input module 1 further comprises a pattern layer 5 which may be formed by printing, engraving or imprinting, and may be selected to be disposed on the first side 111 of the flexible body 11 or on a side of the protection layer 13. In the current embodiment, the pattern layer 5 is disposed on the first side 111 of the flexible body 11 for explanation, but not limited to this. The pattern layer 5 enables the first side 111 to produce the effects of virtual buttons or graphic characters.

The flexible body 11 of the input module 1 in the previous embodiments is made of a polymer selected from the group consisting of polyethylene terephthalate, polycarbonate, polyethylene, polyvinyl chloride, polypropylene, polystyrene, polymethylmethacrylate and a cyclic olefin copolymer, which is thin, light, and flexible and thus is easy for the users to carry.

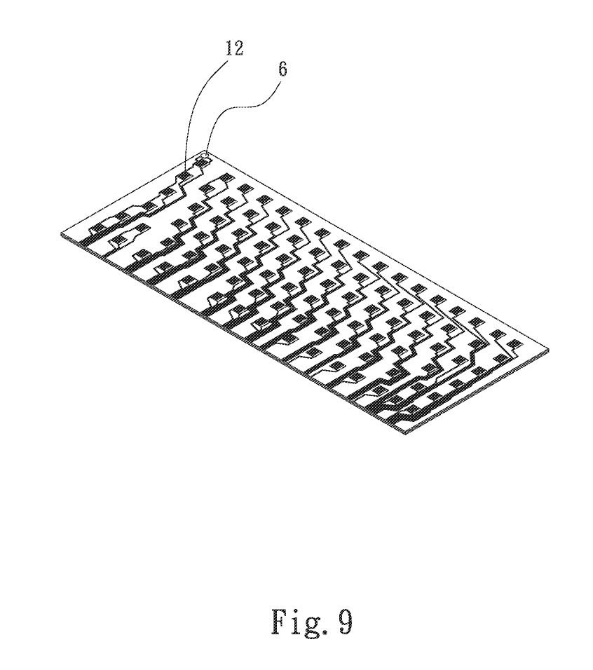

The input module 1 in each of the previous embodiments has functions of handwriting and touch input. A switch unit 6 (shown in FIG. 9) can be disposed to provide the users with the freedom to choose a keyboard or handwriting pad as an input tool. The switch unit 6 is selected from one of a physical button and a slide switch. A physical keyboard in FIG. 9 is used for explanation, but not limited to this. Also, the switch unit 6 is electrically connected to the sensing electrode layer 12.

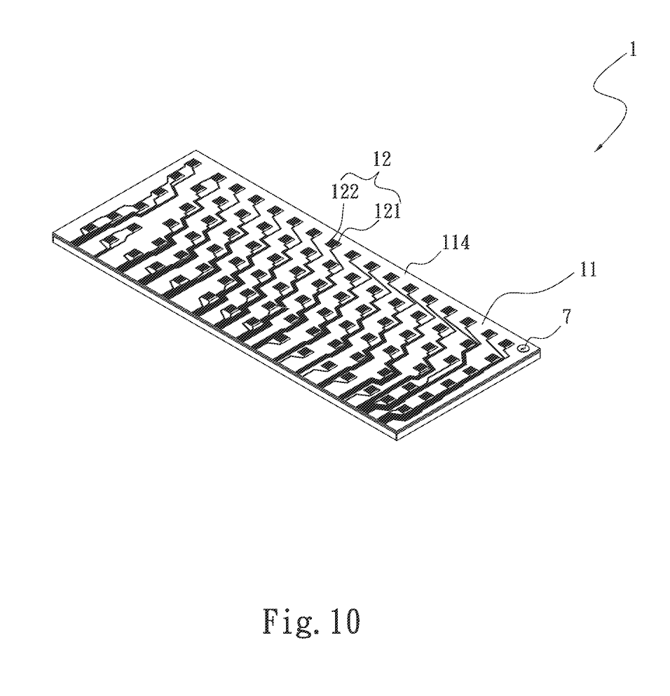

Please refer to FIG. 10, which is the perspective view of an input module according to the seventh embodiment of the present invention. As shown in FIG. 10, some structures of the current embodiment are identical to those of the first embodiment and will not be described again here. The difference between the current and the first embodiments is that in the current embodiment, the input module 1 further comprises a power source 7 disposed in the non-touch area 114 of the flexible body 11 and electrically connected to the first and second sensing electrodes 121, 122. The power source 7 may be selected from one of a rechargeable battery, replaceable battery, solar battery, and bi-energy battery to provide the power for wireless input.

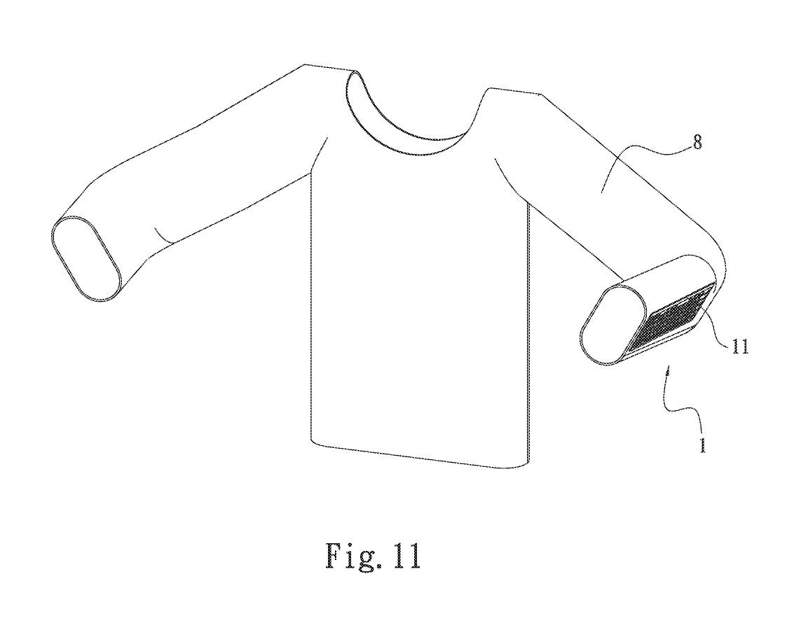

Please refer to FIG. 11, which is the perspective view of an input module according to the eighth embodiment of the present invention. As shown in FIG. 11, some structures of the current embodiment are identical to those of the first embodiment and will not be described again here. The difference between the current and the first embodiments is that in the current embodiment, the input module 1 can be combined with fabric 8 or the flexible body 11 can be directly formed on the fabric 8 using polymers. The fabric 8 can be clothes or other accessories. The wearer can perform the input directly through the input module 1 on the clothes.

What is claimed is:

1. An input module, comprising:
a flexible body having a first side and a second side;
a sensing electrode layer having a first sensing electrode and a second sensing electrode, the first and second sensing electrodes disposed corresponding to and isolated from each other, the sensing electrode layer disposed on the second side of the flexible body;
a protection layer correspondingly disposed on the second side of the flexible body to cover the sensing electrode layer; and
a lighting device having at least one lighting unit and an optical component, the lighting device disposed on a side of the protection layer opposite to the second side of the flexible body.

2. The input module according to claim 1, wherein the flexible body defines a touch area and a non-touch area disposed at the perimeter of the touch area, wherein the first and second sensing electrodes of the sensing electrode layer are disposed within the touch area and partially extend into the non-touch area.

3. The input module according to claim 1, further comprising a flexible circuit substrate electrically connected to the first and second sensing electrodes.

4. The input module according to claim 1, further comprising a wireless emitter electrically connected to the first and second sensing electrodes, wherein the wireless emitter is selected from one of an IR transmitter, Bluetooth transmitter, RF transmitter, and NCF transmission chip.

5. The input module according to claim 1, wherein an anti-interference layer is disposed on a side of the protection layer opposite to the second side of the flexible body.

6. The input module according to claim 1, wherein a pattern layer is disposed on the first side of the flexible body and is formed by printing or engraving.

7. The input module according to claim 1, wherein the flexible body is made of a polymer selected from the group consisting of polyethylene terephthalate, polycarbonate, polyethylene, polyvinyl chloride, polypropylene, polystyrene, polymethylmethacrylate and a cyclic olefin copolymer.

8. The input module according to claim 1, wherein the lighting unit is selected from one of an LED and a CCFL.

9. The input module according to claim 1, wherein the optical component is a light guide plate.

10. The input module according to claim 1, further comprising a switch unit selected from one of a physical button and a slide switch.

11. The input module according to claim 1, wherein the lighting component is a fiber wire.

12. The input module according to claim 1, further comprising a power source disposed in the non-touch area of the flexible body and electrically connected to the first and second sensing electrodes.
